(19) United States
(12) Patent Application Publication
(10) Pub. No.: US 2010/0296155 A1
(43) Pub. Date: Nov. 25, 2010

(54) OPTICAL FIBER RAMAN AMPLIFIER

(75) Inventor: Sergey Sergeyev, Kista (SE)

Correspondence Address: WITHROW & TERRANOVA, P.L.L.C., 100 REGENCY FOREST DRIVE, SUITE 160, CARY, NC, 27518, US

(73) Assignee: WATERFORD INSTITUTE OF TECHNOLOGY, Waterford (IE)

(21) Appl. No.: 12/468,514

(22) Filed: May 19, 2009

(51) Int. Cl. H01S 3/30; B29D 11/00

(52) U.S. Cl. 359/334; 264/1.29

(57) ABSTRACT

The invention provides simultaneous suppression of PMD and PDG in a fiber Raman amplifier. One embodiment employs a two-section fiber with one section being unspun and the other, longer, section having a periodic spin profile. The other embodiment employs a single segment fiber having a periodic exponentially varying spin profile.

### BACKGROUND

An optical fiber Raman amplifier (FRA) is an optical amplifier based on Raman gain in which the Raman-active medium is an optical fiber. An input signal can be amplified while co- or counter-propagating with a pump beam, the wavelength of which is typically a few tens of nanometers shorter. The construction and operation of such amplifiers is very well known. The present invention primarily concerns the optical fiber used in such amplifiers.

Polarization mode dispersion (PMD) in optical fibers is caused by geometry- and stress-based asymmetrical imperfections, and leads to optical pulse broadening due to different group velocities for pulses with orthogonal states of polarization (SOPs). Fiber spinning has been used to suppress PMD for some time, driven by the need to preserve the signal SOP especially for the development of sensing devices, such as magneto-optic current sensors utilizing the Faraday effect, fiber Bragg grating sensors insensitive to transverse force, polarization transformers, and chiral fiber Bragg gratings for optical filters and in-line polarizers.

Recently, the capacity of Internet Protocol (IP) traffic has expanded greatly based on “Fiber to the Home” systems creating a true broadband environment based on an optical fiber network. In addition, there is large demand for the development of high-speed networks for broadcasting media and medical field applications, such as the real-time on-line transmission of very high-resolution images without data compression, and high-quality TV telephony using mobile phones.

Therefore, a backbone optical network with increased optical fiber capacity at low operating and maintaining cost will be beneficial for the telecommunication operators.

This strong demand for increasing bandwidth, distance, and bit rate of signal transmission for broadcasting media and medical applications has renewed attention in optical fibers with PMD reduced by fiber spinning.

Referring to FIG. 1, the modern technology of direct fiber spinning instead of spinning the preform, such as disclosed in U.S. Pat. No. 5,298,047, incorporated herein by reference in its entirety, provides high-speed fiber drawing and flexible control of different spin profiles for better PMD suppression.

In FIG. 1, an optical fiber preform 10 is heated in a furnace 12 to a draw temperature, and an optical fiber 14 is drawn from the heated preform in such a way that a spin is impressed on the fiber. More particularly, a torque is applied to the fiber as it is drawn such that the fiber is caused to twist around its longitudinal axis with a resulting torsional deformation of the fiber material. Upon cooling, the torsional deformation is “frozen” into the fiber so that the fiber exhibits a permanent “spin”, i.e., a permanent torsional deformation.

Typically, it has been determined that a periodic spin profile is optimal, if strong PMD suppression is required, for example, as disclosed in US2008/0022725A1 and US2004/0163418A1, which are incorporated herein by reference in their entireties. Also, a phase modulated spin profile can be employed as disclosed in US2005/0069267A1, incorporated herein by reference in its entirety. Accordingly, the fiber 14 is conventionally drawn with controlled spin parameters providing a periodic spin profile given by A(z)=A₀ sin(2πfₒ z) with maximum spin amplitude A₀ and spin frequency fₒ for PMD suppression.

Separately, broadband fiber Raman amplifiers (FRAs) are used in optical telecom links to reduce the transmission system cost, increase the amplification bandwidth over 100 nm, and extend the link span over 1500 km. However, in Raman amplifiers that make use of fibers with suppressed PMD, the amplified optical pulse is severely distorted due to polarization dependent gain (PDG), i.e., dependence of the Raman gain on pump and signal SOPs.

FIG. 2 shows Raman amplification in a polarization-maintaining (PM) optical fiber. For a PM fiber, if the pump electric-field vector is oriented along a birefringence axis, the difference in the Raman gain values of the orthogonal signal components is maximal and the PDG takes its maximum value, FIG. 2(a). If the pump field is equally shared initially between the two orthogonal states of polarization, the pump SOP evolves through all the possible polarization states and returns to its original state after a beat length L_{b}. On average, the pump power is the same along both orthogonal axes. Hence, there is no difference in the Raman gain values and the PDG becomes zero, FIG. 2(b).

By applying periodic spin, PMD can be suppressed and the fiber approaches a complete isotropic state where there is no absolute anisotropy axis with reference to the whole fiber. Thus, the Raman gain depends only on the relative orientation between the input signal and pump polarizations. In this situation, co-polarized pump and signal waves give the maximum Raman gain and cross-polarized waves result in the minimum gain. Because the pump and signal SOPs do not change along the length of a low PMD fiber, maximum and minimum PDGs converge at the limit value of PDG which is more than 20 dB, such as disclosed by S. Sergeyev, S. Popov, and A. T. Friberg, “Polarization dependent gain and gain fluctuations in a fiber Raman amplifier,” J. Opt. A: Pure Appl. Opt. 9, 1119-1122 (2007), incorporated herein by reference in its entirety, and shown in FIG. 3.

To enable high-speed and long-distance transmission of broadband optical signals, one needs to find a solution that employs a Raman amplifier with minimum dependence on the pump and signal polarizations, while simultaneously keeping PMD suppressed. At first glance, these seem to be mutually excluding requirements if attempted in the same fiber.

Most of the existing schemes to mitigate the PDG are rather expensive, for example, polarization multiplexing of pump laser diodes or application of depolarizers, or not effective, for example, backward pumping or linear-circular conversion of the pump polarization in the case of low PMD fibers.

In relation to backward pumping, if the signal and pump light propagate in opposite directions, the length over which the pump and signal SOPs are correlated is reduced. Because this leads to a decrease not only in PDG, but also in the average gain, this method is not fully effective. Besides, as follows from E. Bettini, A. Galtarossa, L. Palmieri, M. Santagiustina, L. Schenato, and L. Ursini, “Polarized Backward Raman Amplification in Unidirectionally Spun Fibers,” IEEE Photon. Tech. Lett. 20, 27-29 (2008) (incorporated herein by reference in its entirety), PDG for a lumped FRA based on unidirectionally spun fiber can exceed 20 dB for the backward pump, which makes this technique not effective. As follows from FIG. 3, minimum and maximum PDGs converge at low PMD values and, therefore, application of linear-to-circular SOP conversion is not effective for FRA at low PMD.

Another approach to PDG mitigation as disclosed in M. N. Islam, C. DeWilde, and A. Kuditcher, “Wideband Raman amplifiers,” in Raman Amplifiers for Telecommunications 2: Sub-Systems and Systems, ed. Islam, M. N. (Springer, 2004), pp. 445-490 (incorporated herein by reference in its entirety) can be realized by depolarizing (scrambling) the pump source through multiplexing orthogonally polarized pumps with the same laser wavelengths. However, this solution is too expensive to be applied for dense wavelength-division multiplexing (DWDM) systems with a wideband Raman amplifier. Additionally, pump power fluctuations leads to increased degree of polarization for pump and, therefore, to increased polarization dependent gain.

In another solution, as disclosed in H. Kazami, S. Matsushita, Y. Emori, T. Murase, M. Tsuyuki, K. Yamamoto, H. Matsuura, S. Namiki, and T. Shiba, “Development of a crystal-type depolarizer,” Furakawa Review 23, 44-47 (2003), incorporated herein by reference in its entirety, a depolarizer is used to convert, completely or partially, polarized light from a pump laser diode (LD) into unpolarized light. However, temperature fluctuations cause fluctuations in the input SOP around linearly polarized states. This leads to unequal powers of the two linearly polarized modes inside the depolarizer and results in a partially polarized output with the degree of polarization (DOP) fluctuating between 4% and a maximum of 15%. This means that for low PMD fibers (PMD parameter Dₚ<0.03 ps/km^{-1/2}) where PDG is more than 20 dB, the PDG value will exceed 6 dB.

### SUMMARY OF THE INVENTION

According to the invention there is provided an optical fiber Raman amplifier with simultaneous suppression of polarization mode dispersion and polarization dependent gain, the amplifier comprising an optical fiber having first and second contiguous lengths L₁ and L₂, L₂ being greater than L₁, wherein the length L₁ is unspun and the length L₂ has an impressed spin profile given by 2A₀π f₀ cos(2π f₀z) where z is the direction along the drawn fiber, A₀ is the maximum spin amplitude, and f₀ is the spin frequency, wherein L1 is at least approximately equal to nT/2, where n is an integer and T is the period of spatial oscillation of the pump-to-signal state of polarization projections.

The invention also provides an optical fiber Raman amplifier with simultaneous suppression of polarization mode dispersion and polarization dependent gain, the amplifier comprising an optical fiber having an impressed spin profile given by 2A₀π f₀ cos(2πf₀z)(1−exp(−z/L₁)) where z is the direction along the drawn fiber, A₀ is the maximum spin amplitude, and f₀ is the spin frequency, wherein L1 is at least approximately equal to nT/2, where n is an integer and T is the period of spatial oscillation of the pump-to-signal state of polarization projections.

The invention also provides methods of making an optical fiber Raman amplifier as specified above.

The invention provides a cost-effective technique to suppress both the PMD and PDG to an extremely low level, for example, PDG=0.1 dB and Dₚ=0.005 ps·km^{-1/2}.

The technique of simultaneous suppression of PDG and PMD proposed herein is much cheaper than multiplexing orthogonally polarized pumps and more effective than the other approaches.

The major value of the invention is that with the help of the application of a wideband fiber Raman amplifier with tailored polarization properties it is possible to meet requirements of increased optical fiber capacity at reduced operating and maintaining cost through optimization of three factors:

Firstly, a single FRA requires fewer components than a split band amplifier (erbium doped fiber amplifier, linear optical amplifier, semiconductor optical amplifier etc.), thereby reducing the equipment cost.

Secondly, with a single wideband FRA it is possible to reach a 100 nm amplification bandwidth, i.e. a channel count of 240 with channel spacing of 50 GHz (0.4 nm).

Thirdly, with the help of a distributed FRA it is possible to increase bit rate above 40 Gb/s through minimization of the transmission impairments caused by polarization mode dispersion and polarization dependent gain of FRA. Finally, the application of FRA will maximize the transmission distance over 1500 km.

### BRIEF DESCRIPTION OF THE DRAWINGS

Embodiments of the invention will now be described, by way of example, with reference to the accompanying drawings, in which:

FIG. 1 shows the conventional drawing of a spun fiber with controlled spin parameters for PMD suppression.

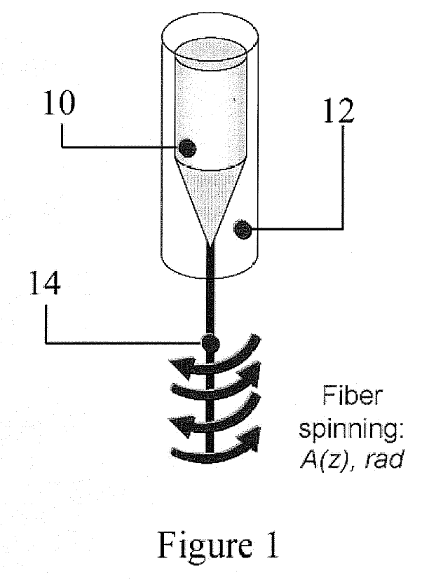

FIG. 2 shows optical pulse distortion in terms of the differential group delay (DGD) caused by polarization mode dispersion (PMD) and polarization dependent gain (PDG) in a Raman fiber amplifier with a fixed birefringence, e.g., a polarization-maintaining (PM) fiber, where: (a) shows a pump electric-field vector oriented along a birefringence axis, and (b) shows a pump field equally shared between the two orthogonal states of polarization.

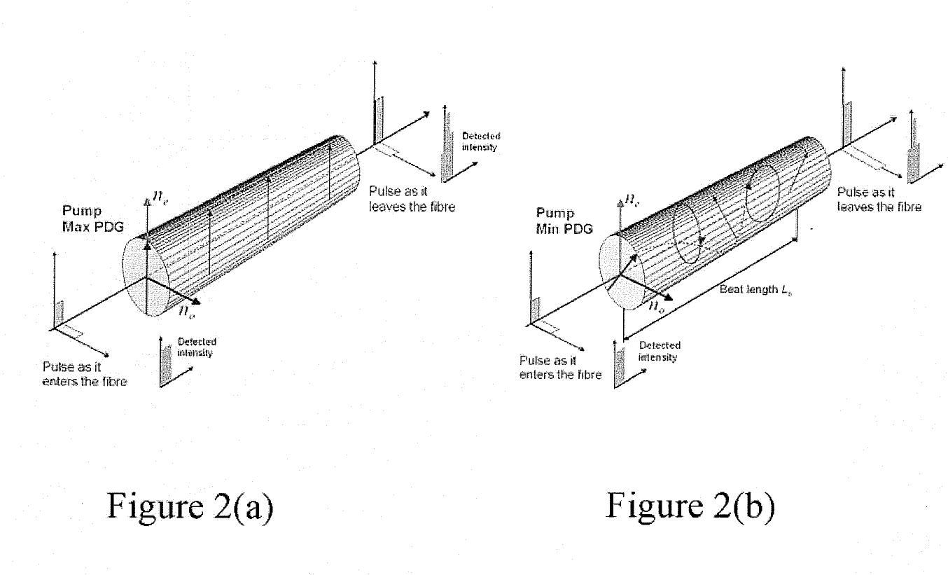

FIG. 3 shows polarization dependent gain as function of polarization mode dispersion parameter in a typical Raman amplifier.

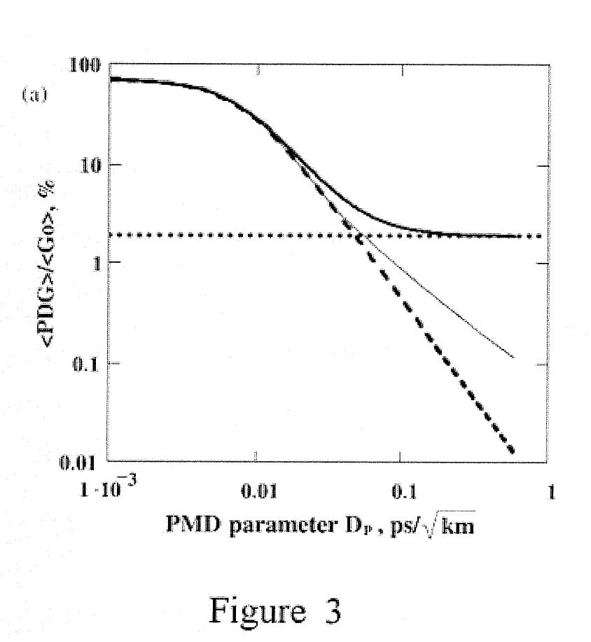

FIG. 4 is a projection of the signal state of polarization to the pump state of polarization <x> corresponding to the minimum (dotted line) and maximum (solid line) PDG. The projections for the maximum gain are indicated by (i) and for the minimum gain by (ii). FIG. 4(a) shows the situation with no spin, and FIG. 4(b) shows the situation with optimal spin profile: A=0 for z≦L₁, periodic for z>L₁.

FIG. 5 shows the spin-induced reduction factor (SIRF))(i), and the minimum (ii) and maximum (iii) polarization dependent gain (PDG) as a function of the spinning amplitude A₀. Approximations: the SIRF of the first section of fiber without spin is shown at (iv), the max and min PDGs for a fiber without spin and the same length as two-section fiber are shown at (v) and (vi) respectively. Spin rates: (a) optimal (α=0 for z≦L₁, periodic α(z)=2πf₀A₀ cos(2π f₀z) for z>L₁), (b) periodic-exponentially varying α_{EXV}(z)=2A₀π f₀ cos(2π f₀z)[1−exp(−z/L₁)].

FIG. 6 shows the spin-induced reduction factor (SIRF) (solid line), and the minimum and maximum polarization dependent gain PDG (dashed line) as a function of the spinning amplitude A₀ for periodic spin rate rad.

FIG. 7 shows SIRF and PDG values as a function of fiber correlation length L_{c} and PMD parameter. Parameters: Dₚ=0.03 ps·km^{-1/2} (solid line), Dₚ=0.05 ps·km^{-1/2} (dotted lines), Dₚ=0.1 ps·km^{-1/2} (dashed line).

### DESCRIPTION OF THE PREFERRED EMBODIMENTS

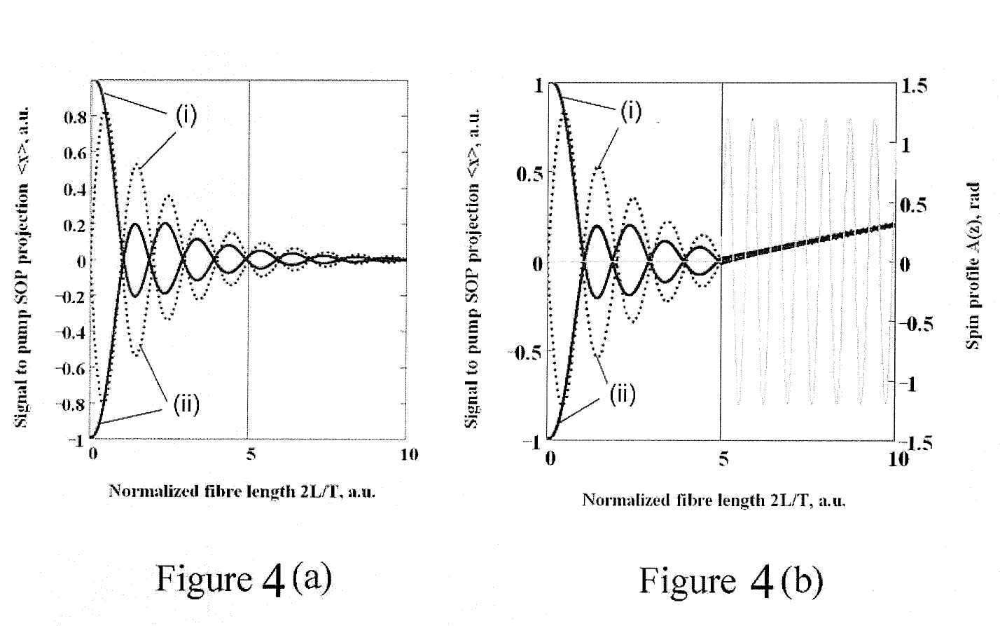

Sergeyev et al disclose that for fibers without spin, the pump-to-signal SOP projections corresponding to the max/min Raman gain, i.e., <xₘₐₓ> and <xₘᵢₙ>, oscillate in anti-phase along the fiber and merge at distances of zₙ=(nT)/2, where T is the spatial period and n is an integer. The max/min Raman gain is proportional to the corresponding projections <xₘₐₓ> and <xₘᵢₙ> averaged along the fiber, FIG. 4(a).

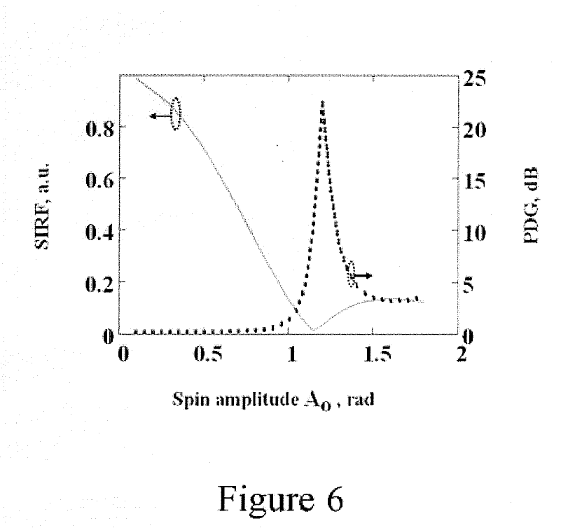

Separately, referring to FIG. 6, it is well known that the spin-induced reduction factor (SIRF) for the periodic spin rate can reach a minimum value of less than approximately 0.01 for the phase-matching condition A₀≈1.2, for example, as disclosed in R. E. Schuh, X. Shan, and A. S. Siddiqui, “Polarization mode dispersion in spun fibers with different linear birefringence and spinning parameters,” J. Lightwave Technol. 16, 1583-1588 (1998), which is incorporated herein by reference in its entirety.

However, while it is possible to reach a value of 0.013 for SIRF (Dₚ=0.0026 ps·km^{-1/2}) for a single section fiber with a periodic spin rate under phase-matching condition A₀≈1.2 mentioned above, the PDG for this condition takes the value of 22.4 dB—so this would not make for a good amplifier.

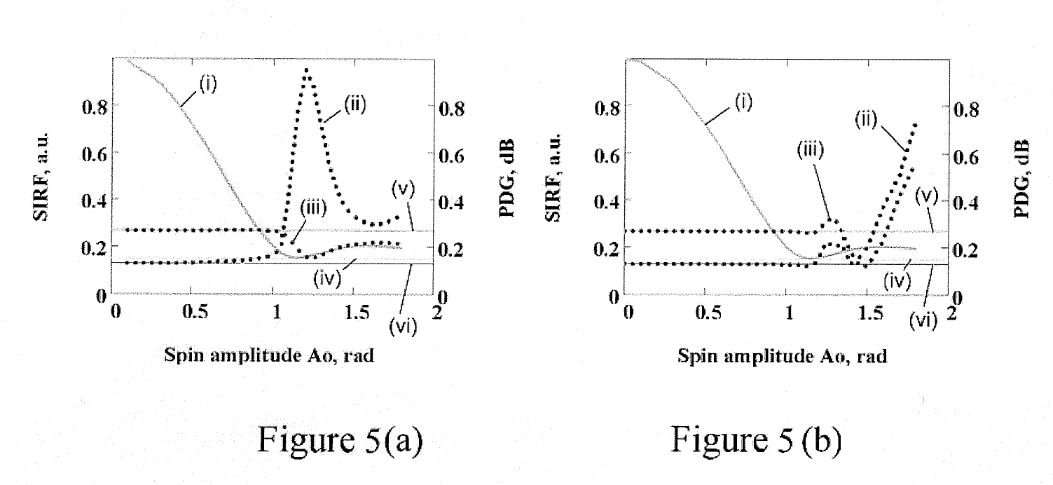

In order to suppress both PDG and PMD, in a first embodiment a short length (L₁=zₙ) of unspun optical fiber is contiguous with a much longer length of periodically spun fiber. For this embodiment, projections <xₘₐₓ> and <xₘᵢₙ> are the same at the input of the length of periodically spun fiber and, therefore, do not contribute to the PDG over the length of this fiber for a wide range of spinning amplitudes—FIGS. 4(b) and 5(a). It means that for a two-section fiber, polarization dependent gain is the same as for a single section fiber without spin, i.e. it can be very small, FIG. 5.

Therefore for this case, the differential group delay (DGD):

\sqrt{ [symbol]Δτ(L)² [symbol]}=Dₚ\sqrt{L}

where L is the fiber length and Dₚ is the polarization mode dispersion parameter (PMD), for a long-length periodically spun fiber is much less than DGD for a short section of fiber without spin. Thus, the SIRF for two-sections of long-length fiber is approximately equal to the SIRF of the first section of fiber without spin. Because the first section is small, the SIRF can be reduced to a small level as well, FIG. 5.

In the first embodiment, therefore, the optical fiber has first and second contiguous lengths L₁ and L₂, L₂ being greater than L₁, wherein the length L₁ is unspun and the length L₂ has an impressed spin profile given by 2A₀π f₀ cos(2π f₀z). L₂ is preferably at least two orders of magnitude (10²) greater than L₁.

In a second embodiment the optical fiber has an impressed spin profile given by 2A₀π f₀ cos(2π f₀z)(1−exp(−z/L₁)).

In each case z is the direction along the drawn fiber, A₀ is the maximum spin amplitude, and f₀ is the spin frequency. Furthermore, in each case L1 is at least approximately equal to nT/2 (e.g. within 10% of nT/2), where n is an integer and T is the period of spatial oscillation of the pump-to-signal state of polarization projections.

In these embodiments f₀L_{b}=3 and L_{b}=8.17 m. In the first embodiment, a figure of n=5 is chosen as the effect of the estimation of T is less than if n were equal to 1, but balanced against keeping the length of the unspun section relatively short vis-à-vis the spun section to minimize Dp for the combined fiber.

To verify the method of simultaneous mitigation of PMD and PDG, one can use the model of PMD in spun fibers disclosed by A. Pizzinat, B. S. Marks, L. Palmieri, C. R. Menyuk, and A. Galtarossa, “Influence of the model for random birefringence on the differential group delay of periodically spun fibers,” IEEE Photon. Technol. Lett. 15, 819-821 (2003), incorporated herein by reference in its entirety, and use an advanced model of fiber Raman amplifier accounting for the fiber spin profile, PMD value, and pump SOP. The results for both a two-section fiber, i.e. unspun/periodically spun, and a fiber with periodic-exponentially varying spin are shown in FIGS. 5(a) and 5(b).

As follows from FIGS. 5(a) and 5(b), the simplified approach (contiguous spun/unspun fiber sections) and advanced model (single fiber section with periodic exponentially varying spin) lead to quite low values for PDG in the wide range of spin amplitudes A₀ and for SIRF at A₀≈1.2. Thus, both embodiments demonstrate an opportunity to reduce the PDG and SIRF to the values acceptable for high-speed telecommunication, namely PDG=0.13 dB and SIRF=0.16, i.e. Dₚ=0.032 ps·km^{-1/2}.

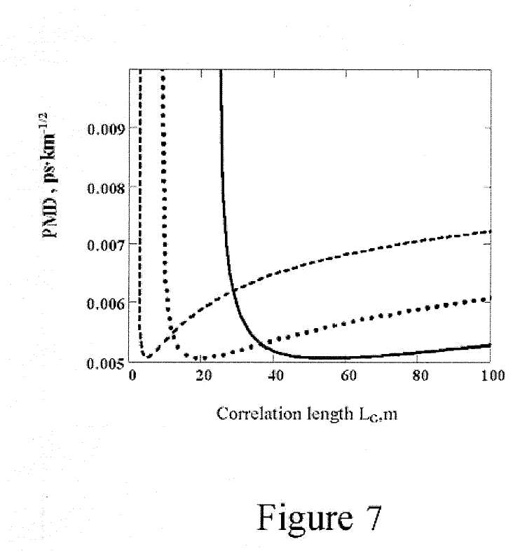

Because the simplified approach leads to results which are quite close to the results of modeling based on the advanced model, it can be used for optimization of the fiber spin profile that can result in additional suppression of PMD and PDG values. The results for SIRF as a function of fiber correlation length and PMD parameter are shown in FIG. 7.

As follows from FIG. 7, the optimal parameters can be specified as follows: Dₚ=0.1 ps·km^{-1/2}, L_{c}=5 m, L₁=T/2=56.2 m. As a result, PDG and PMD can be suppressed to 0.1 dB and 0.005 ps·km^{-1/2} in two-section fiber (unspun/periodically spun) and fiber with periodic-exponentially varying spin.

In both embodiments the optical fiber can be provided with the desired spin profile by suitable control of the apparatus described in U.S. Pat. No. 5,298,047, and the way the fibers are incorporated into a Raman amplifier is well-known.

To summarize, the invention provides simultaneous suppression of PMD and PDG in a fiber Raman amplifier. The two embodiments can be generalized in one functional form: α_{gen}(z)=α(z)F(z,L₁), where α(z) is the spin rate which result in PMD suppression only, and F(z,L₁) is a function which results in further suppression of PDG, for example, F(z,L₁)=H(L₁) for the two-section fiber or F(z,L₁)=1−exp(−z/L₁) for the periodic-exponentially varying spin profile.

The characteristic length L₁ is the parameter of optimization. It can be chosen, for example, as L₁=nT/2, where T is the period of spatial oscillation of the pump to signal state of polarization projections. The minimum required length of the first section of fiber L₁ is L₁=T/2=2πL_{c}/{square root over (4[π Dₚ⁽¹⁾c\sqrt{2L_{c}}(1/λₚ−1/λₛ)]²−1/4)}, where λₚ and λₛ are the pump and signal wavelengths, Dₚ⁽¹⁾ is the PMD parameter of the first section of fiber in the first embodiment or the fiber in the second embodiment, L_{c} is the correlation length, and c is the speed of light.

This is used as an estimate in the present embodiments. However, for optimization purposes, for example, for further suppression of polarization dependent gain, the parameter L₁ can be chosen as L₁≠nT/2 provided that it approximates it, e.g. it is within 10% of nT/2.

For the two-section fiber, the chosen parameters of a short section of fiber result in decaying oscillations of the pump to signal projections of the states of polarization (SOPs). SOP projections oscillate in anti-phase and converge at some characteristic distance, which defines the length of the shorter section of the fiber. The combination of the short-length fiber with the long periodically spun fiber mitigates the PDG and PMD simultaneously. As a result, the projections are the same at the input of periodically spun fiber, and, therefore, they do not contribute to the polarization dependent gain over a wide range of spinning amplitudes.

Since the first unspun section is much shorter than the periodically spun fiber, the composition of the two fibers will lead to suppressed PMD value for phase matching condition.

The second embodiment of a fiber with periodic-exponentially varying spin leads to the further suppression of polarization dependent gain.

The invention is not limited to the embodiments described herein which may be modified or varied without departing from the scope of the invention.

1. An optical fiber Raman amplifier with simultaneous suppression of polarization mode dispersion and polarization dependent gain, the amplifier comprising an optical fiber having first and second contiguous lengths L₁ and L₂, L₂ being greater than L₁, wherein the length L₁ is unspun and the length L₂ has an impressed spin profile given by 2A₀π f₀ cos(2π f₀z) where z is the direction along the drawn fiber, A₀ is the maximum spin amplitude, and f₀ is the spin frequency, wherein L1 is at least approximately equal to nT/2, where n is an integer and T is the period of spatial oscillation of the pump-to-signal state of polarization projections.

2. An amplifier as claimed in claim 1, wherein L1 is given by L₁=T/2=2πL_{c}/{square root over (4[πDₚ⁽¹⁾c\sqrt{2L_{c}}(1/λₚ−1/λₛ)]²−1/4)}, where λₚ and λₛ are the pump and signal wavelengths, Dₚ⁽¹⁾ is the PMD parameter of the first length of fiber, c is the speed of light, and L_{c} is the correlation length.

3. An amplifier as claimed in claim 1, wherein n=5.

4. An amplifier as claimed in claim 1, wherein the spun length L₂ is chosen such that the PMD parameter of the combined length (L₁+L₂) of the optical fiber is approximately the same as the PMD parameter of the spun length L₂ alone.

5. An amplifier as claimed in claim 4, wherein L₂ is at least two orders of magnitude (10²) greater than L₁.

6. An amplifier as claimed in claim 5, wherein L₂ is approximately 10 km·7. An amplifier as claimed in claim 1, wherein the unspun length of fiber has a length L₁=56.2 m, a PMD parameter Dₚ=0.1 ps/km^{-1/2}, and a correlation length L_{c}=5 m.

8. An amplifier as claimed in claim 1, wherein the unspun length of fiber has a PMD parameter Dp=0.03 ps/km^{-1/2}, and a correlation length greater than 40 m.

9. An amplifier as claimed in claim 1, wherein the unspun length of fiber has a PMD parameter Dp=0.05 ps/km^{-1/2}, and a correlation length greater than 20 m.

10. An optical fiber Raman amplifier with simultaneous suppression of polarization mode dispersion and polarization dependent gain, the amplifier comprising an optical fiber having an impressed spin profile given by 2A₀π f₀ cos(2π f₀z)(1−exp(−z/L₁)) where z is the direction along the drawn fiber, A₀ is the maximum spin amplitude, and f₀ is the spin frequency, wherein L1 is at least approximately equal to nT/2, where n is an integer and T is the period of spatial oscillation of the pump-to-signal state of polarization projections.

11. An amplifier as claimed in claim 10, wherein L1 is given by L₁=T/2=2πL_{c}/{square root over (4[πDₚ⁽¹⁾c\sqrt{2L_{c}}(1/λₚ−1/λ₂)]²−1/4)}, where λₚ and λₛ are the pump and signal wavelengths, Dₚ⁽¹⁾ is the PMD parameter of the fiber, c is the speed of light, and L_{c} is the correlation length.

12. An amplifier as claimed in claim 10, wherein n=5.

13. A method of making an optical fiber Raman amplifier with simultaneous suppression of polarization mode dispersion and polarization dependent gain, comprising providing an optical fiber preform, heating the preform, and drawing an optical fiber from the heated preform such that a length L₁ is unspun and a length L₂ contiguous with and greater than the length L₁ has an impressed spin profile given by 2A₀π f₀ cos(2π f₀z) where z is the direction along the drawn fiber, A₀ is the maximum spin amplitude, and f₀ is the spin frequency, wherein L1 is at least approximately equal to nT/2, where n is an integer and T is the period of spatial oscillation of the pump-to-signal state of polarization projections.

14. A method as claimed in claim 13, wherein L1 is given by L₁=T/2=2πL_{c}/{square root over (4[πDₚ⁽¹⁾c\sqrt{2L_{c}}(1/λₚ−1/λₛ)]²−1/4)}, where λₚ and λₛ are the pump and signal wavelengths, Dₚ⁽¹⁾ is the PMD parameter of the first length of fiber, c is the speed of light, and L_{c} is the correlation length.

15. A method as claimed in claim 13, wherein n=5.

16. A method as claimed in claim 13, wherein the spun length L₂ is chosen such that the PMD parameter of the combined length (L₁+L₂) of the optical fiber is approximately the same as the PMD parameter of the spun length L₂ alone.

17. A method as claimed in claim 16, wherein L₂ is at least two orders of magnitude (10²) greater than L₁.

18. A method as claimed in claim 17, wherein L₂ is approximately 10 km.

19. A method as claimed in claim 13, wherein the unspun length of fiber has a length L₁=56.2 m, a PMD parameter Dp=0.1 ps/km^{-1/2}, and a correlation length Lc=5 m.

20. A method as claimed in claim 13, wherein the unspun length of fiber has a PMD parameter Dp=0.03 ps/km^{-1/2}, and a correlation length greater than 40 m.

21. A method as claimed in claim 13, wherein the unspun length of fiber has a PMD parameter Dp=0.05 ps/km^{-1/2}, and a correlation length greater than 20 m.

22. A method of making an optical fiber Raman amplifier with simultaneous suppression of polarization mode dispersion and polarization dependent gain, comprising providing an optical fiber preform, heating the preform, and drawing an optical fiber from the heated preform such that the fiber has an impressed spin profile given by 2A₀π f₀ cos(2π f₀z)(1−exp(−z/L₁)) where z is the direction along the drawn fiber, A₀ is the maximum spin amplitude, and f₀ is the spin frequency, wherein L1 is at least approximately equal to nT/2, where n is an integer and T is the period of spatial oscillation of the pump-to-signal state of polarization projections.

23. A method as claimed in claim 22, wherein L1 is given by L₁=T/2=2πL_{c}/{square root over (4[πDₚ⁽¹⁾c\sqrt{2L_{c}}(1/λₚ−1/λₛ)]²−1/4)}, where λₚ and λₛ are the pump and signal wavelengths, Dₚ⁽¹⁾ is the PMD parameter of the fiber, c is the speed of light, and L_{c} is the correlation length.

24. A method as claimed in claim 22, wherein n=5.
